(19) United States
(12) Patent Application Publication
(10) Pub. No.: US 2026/0003831 A1
(43) Pub. Date: Jan. 1, 2026

(54) Method and electronic device for generating a structured database of relevant data for managing a task, and associated computer program

(71) Applicant: THALES, COURBEVOIE (FR)

(72) Inventors: Jaime DIAZ PINEDA, MERIGNAC (FR); Thomak LEDUC, MERIGNAC (FR); Aurelien THIRIET, MERIGNAC (FR)

(21) Appl. No.: 18/246,850

(22) PCT Filed: Sep. 29, 2021
(86) PCT No.: PCT/EP2021/076830

§ 371 Date: Sep. 4, 2025

(30) Foreign Application Priority Data
Oct. 1, 2020 (FR) FR2010033

(51) Int. Cl. G06F 16/21

(52) U.S. Cl. CPC G06F 16/21

(57) ABSTRACT

Generating, from a set of databases, a structured database associated with a task, including acquiring a list of required action(s) and a group of data extraction rules each including an extraction law, generating a structure of the structured database including at least one class of unsuccessful queries, sending the extraction rule(s) to the set and receiving extracted data from the set, storing the or each received extracted data in a class of the structured database, and for each sent extraction law, if no retrieved data is received in response from the set, associating the law with the class of unsuccessful queries.

### REFERENCE TO RELATED APPLICATIONS

This application claims benefit under 35 USC § 371 of PCT Application No. PCT/EP2021/076830 entitled METHOD AND ELECTRONIC DEVICE FOR GENERATING A STRUCTURED DATABASE OF RELEVANT DATA FOR MANAGING A TASK, AND ASSOCIATED COMPUTER PROGRAM, filed on Sep. 29, 2021 by inventors Jamie Diaz Pineda, Thomak Leduc and Aurelien Thiriet. PCT Application No. PCT/EP2021/076830 claims priority of French Patent Application No. 20 10033, filed on Oct. 1, 2020.

### TECHNICAL FIELD OF THE INVENTION

The present invention relates to a method for generating, from a set of databases, a structured database of data associated with a task, the method being implemented by an electronic generation device.

The invention also relates to a computer program comprising software instructions which, when executed by a computer, implement such a generation method.

The invention also relates to an electronic generation device configured to generate, from a set of databases, a structured database associated with a task.

### BACKGROUND OF THE INVENTION

The invention applies to the field of decision support for a user faced with a critical situation during a task. A critical situation is understood here to mean an event during the task, for which action is required in order not to jeopardize the task.

In the aeronautical domain, a task is for example the flight of an aircraft to transport passengers between two airports. A critical situation would then be, for example: an engine failure of the aircraft, a health problem of a passenger, or bad weather conditions on the route of the aircraft.

A decision making performance of the user depends on their ability to assess the critical situation. According to M. R. Ensley's “Toward a theory of situation awareness in dynamic systems” in Volume 37 of The Journal of the Human Factors and Ergonomics Society in 1995, such an assessment comprises three steps: perception of the elements of the situation, understanding of said elements, and determination of the most appropriate decision from a set of possible decision(s).

The perception stage consists in acquiring a set of elements describing the situation. However, the environment may be overloaded with elements that are not relevant to the activity of the operator. The relevance of a data is understood here in the sense of a characteristic that the data has to be appropriate, or even adapted, for the comprehension of the situation. In the context of the above-mentioned document, the elements are understood in the sense of relevant data.

The perception step is then essential because an error during this step has repercussions on the understanding and determination steps, and more particularly on a sub-step of projection of future states during the determination step. In particular, failure to take into account certain relevant data leads to a misunderstanding of that data, causing potentially inappropriate decisions.

Thus, when making a decision in a critical situation, the user or the system must be able to analyze a set of data of which only a part is relevant. To increase the probability that relevant data will be accessible, databases have been created that contain the most exhaustive data sets possible. For example, the ICAO Meteorological Exchange Model database contains global meteorological data.

When the situation encountered does not require a quick decision, or the user is not constrained by stress, fatigue or distraction, it is possible for the user to consult all the data. The user then selects the relevant data and deduces the best decision for the situation.

However, when faced with a critical, time constrained situation, or the user is constrained by one of the above mentioned factors, it is no longer possible for the user to analyze all the data without ignoring or forgetting some relevant data.

For this, some methods propose to automatically extract part of the data from the database(s), called source(s), according to pre-established extraction rules. The extracted data is then indexed in a new database, called target, smaller than the source database(s). The contribution of a structure to the target database, organizing the extracted data, allows the links between the extracted data to be represented and to simplify the understanding of this data.

Such extractions and indexations are proposed in the document “A Method to Identify Relevant Information Sufficient to Answer Situation Dependent Queries” by S. Lu and M. M. Kokar describing a method for automatically extracting a set of data from a source database. The method also comprises the creation of a target database and the storage of the extracted data in this database. The choice of the data extracted from the source database is a function of the situation encountered, and is, for example, determined by an analysis based on a so-called theory of situation.

The presented extraction and classification method allows a target database to be constituted comprising a smaller amount of data than the source database. Moreover, each data item of the source database, considered as relevant vis-a-vis the theory of situation, is well present in the target database. Thus, the target database is more easily processed by a user, for the understanding of the situation and the decision making

Nevertheless, the extraction and generation process of Lu and Kokar does not allow to generate a target database in an optimal route.

### SUMMARY OF THE INVENTION

An aim of the invention is then to improve the data extraction and the generation of the target database.

To this end, the invention has as its object a method for generating from a set of databases, a structured database associated with a task, the method being implemented by an electronic generation device and comprising the following steps:
acquiring a list of actions required during the task, and a group of data extraction rules from the set of databases, each extraction rule including a first identifier of a class of the structured database and a law for extracting data from the database(s), each rule being associated with one or more required action(s),
generating a structure of the structured database including at least one class for each first identifier of a distinct class, and a class of unsuccessful queries,
selecting extraction rules from among the acquired group of extraction rules, as a function of a required action chosen by a user from among the list of required action(s),
sending the extraction law included in each selected extraction rule, to the set of databases, and receiving extracted data from the databases as a result of this sending,
storing the or each received extracted data in the class of the structured database corresponding to the first identifier of a class associated with the extraction law in response to which said data was received, and
for each extraction law sent, if no extracted data is received in response from the set of databases, associating said law with the class of unsuccessful queries.

Thus, the method according to the invention allows to generate a structured database comprising the data extracted from a set of databases, also called source databases.

Furthermore, the choice of a required action by a user and the selection of extraction rules, based on this choice, allows a reduced number of extractions to be performed while allowing each extracted data to be appropriate in the context of the chosen required action.

Moreover, the presence in each extraction rule of a first identifier of a class allows to organize the structured database independently of the structure of the or each source database.

Moreover, the step of associating the extraction law to the class of unsuccessful queries allows to identify the absence, in the set of source databases, of data corresponding to a sent extraction law, which then allows the user of the structured database to differentiate between data absent from the set of source databases but considered relevant and searched by an extraction law, and data absent from the structured database because it is considered irrelevant and for which no extraction law has tried to extract it.

According to other advantageous aspects of the invention, the method according to the invention comprises one or more of the following features taken alone or in any technically possible combination:
following the sending of an extraction law, no extracted data is received from the set of databases if the message(s) received from the set of databases only verify at least one of the following cases:
an error message is received from the set of databases,
a message including an empty data field is received from the set of databases
the database set comprises at least two databases, and during the sending step, the extraction law included in each selected extraction rule is sent to each database,
if the databases provide at least two different extraction data in response to a same sent extraction law, the at least two extraction data are, during the storage step, stored in the same class of the structured database, corresponding to the first identifier of a class associated to said extraction law,
following the sending of an extraction law, each received data comprises:
a set of data extracted from a database, in response to the sent extraction law,
a set of second identifiers of a class of the database from which the extracted data set(s) is derived, each second identifier corresponding to a respective class of said database from which at least one respective extracted data set is derived, and
a group of data extraction criteria from the database from which the extracted dataset is derived,
the set of second identifiers and the group of criteria being specific to each database and being generated from the sent extraction law,
during the storage step, the set of second identifiers, the group of criteria and the data sets are stored in the class corresponding to the first identifier of a class associated with said extraction law,
during the storage step, at least a first relationship between an extracted data and a second identifier of a class is further stored in said class of the structured database,
the task is the flight of an aircraft,
the set of required actions preferably comprises: a start of the aircraft, a diversion of the aircraft, and a bypassing by the aircraft of a geographical zone
the extraction rules associated with the required diversion action comprise the extraction laws:
   find an airport with a runway length greater than a predefined length,
   find an airport with weather conditions corresponding to predefined conditions,
   find an airport with emergency services, and
   find an airport that is distant from the aircraft by at most a predefined maximum distance D₁ₘₐₓ,
and in which the extraction rules associated with the required diversion action comprise the extraction laws:
   find the coordinates of aircraft waypoint(s) for which the weather conditions correspond to predefined conditions, and distant from the aircraft by at most a second predefined maximum distance D₂ₘₐₓ.
during the acquisition step, the invariant data of the task are also acquired, and during the sending step, at least one sent extraction law is completed by at least one invariant data during the task,
if the task is the flight of an aircraft, the invariant data during the task preferably comprises a type or model reference of the aircraft, a flight number of an aircraft, a departure airport of the aircraft, an initial amount of fuel in the aircraft,
the method further comprises, after the storage or association step:
a step of retrieving a request from a user, and
if the request is for an extraction law associated with the class of unsuccessful queries, a step of communicating a message, indicating that the data responding to the request is missing from the database sets, to the user.

As an optional addition, each extraction law includes a set of keywords able to be translated into second identifiers of a class of each database when sending said law, if at least two second identifiers, associated to the same keyword of an extraction law, are then received during the storage step, a second relationship is stored in the structured database.

As a further optional addition, during the association step, each sent extraction law for which no extracted data is received, is qualified as unsuccessful, and each unsuccessful law is associated with the unsuccessful queries class according to one of the following two conditions:
if each keyword of the unsuccessful law, is associated with a second identifier, then storage of the unsuccessful queries class contains:
   each second identifier absent from the structured database,
   each extraction criterion absent from the structured database, and
   at least a third relationship linking a respective second identifier to a respective extraction criterion, or two of said second identifiers if the law comprises at least two keywords,
if at least one keyword of the unsuccessful law is not associated with a second identifier, then storing in the unsuccessful queries class of:
   each second identifier absent from the structured database,
   each keyword not associated with a second identifier,
   each extraction criterion absent from the structured database, in each extraction criterion related to a keyword without a second identifier, the second identifier being replaced by the keyword, and
   at least one fourth relationship linking a keyword to a respective extraction criterion or to a respective second identifier if the law comprises two keywords.

The invention also has as its object a computer program including the software instructions which, when executed by a computer, implement a method according to any of the preceding claims.

The invention also has as its object an electronic generation device configured to generate, from a set of databases, a structured database associated with a task, the device being able to be connected to a set of databases, the electronic generation device comprising:
an acquisition module configured to acquire a list of actions required during the task, and a group of rules for extracting data from the set of databases, each extraction rule including a first identifier of a class of the structured database and a law for extracting data from the database, each rule being associated with one or more required actions
a generation module configured to generate a structure of the structured database including at least one class for each distinct first identifier of a class, and a class of unsuccessful requests
a selection module configured to select one or more extraction rules from the acquired group of extraction rules, based on a required action chosen by a user from the list of required actions
a sending module configured to send the extraction law included in each selected extraction rule to all the databases, and a module for receiving data from the databases following this sending,
a storage module configured to store the or each received data in the class of the structured database (corresponding to the first identifier of a class associated with the extraction law in response to which said data was received, and
an association module configured to associate each sent extraction law, for which no extracted data is received in response from all the databases, with the class of unsuccessful requests.

### BRIEF DESCRIPTION OF THE DRAWINGS

These features and advantages of the invention will become clearer upon reading the following description, given only as a non-limiting example, and made with reference to the attached drawings, in which:

FIG. 1 is a schematic representation of a system for generating a structured database according to the invention, the system comprising a set of databases and an electronic device for generating, from the set of databases, a structured database;

FIG. 2 is a flowchart of a method, according to the invention, of generating a structured database according to the invention, the method being implemented by the electronic generation device of FIGS. 1; and 10

FIG. 3 is a schematic representation of a structured database, generated according to the generation method represented in FIG. 2.

### DETAILED DESCRIPTION

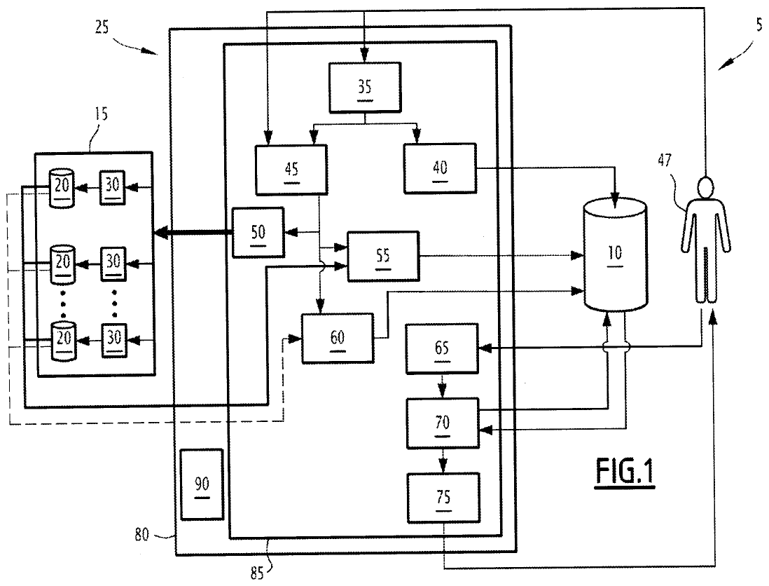

In FIG. 1, a system 5 for generating a structured database 10 of data comprises a set 15 of databases 20 and an electronic device 25 for generating the structured database 10. The generation device 25 is connected to the set 15. The generation system 5 is typically configured to generate a respective structured database 10 per task. The task is, for example, the flight of an aircraft for transporting a passenger or passengers.

The structured database 10 is for example a knowledge base. The term “knowledge base” is understood here in the sense of a structured database, also including linking elements, hereafter called relationships, allowing to establish semantic links between the data of the base, as defined in the chapter “Knowledge Bases vs Databases” of the book “On Knowledge Base Management Systems”, published in 1986, and written by Michael L. Brodie and John Mylopoulos.

The set 15 comprises at least one database 20, each database 20 being also referred to as source base 20 hereafter, and at least one translator 30 specific to each source base 20.

The set 15 is likely to evolve dynamically during the method. Thus, the presence of each source base 20 is not determined beforehand. The continuous presence of at least one source base 20 and the associated translator 30, is the only constraint, or requirement, associated with the set 15.

The generation device 25 is configured to generate the structured base 10 from said set 15.

The generation device 25 comprises an acquisition module 35 configured to acquire at least one list of actions required during the task and a group of extraction rules, each comprising an extraction law. The generation device 25 comprises a generation module 40 configured to generate a structure of the structured database 10.

The generation device 25 also comprises a selection module 45 configured to select one or more extraction rule(s) from among the group of extraction rules based on a required action selected by a user 47, a sending module 50 configured to send, to the set 15, the extraction law included in each selected extraction rule.

The generation device 25 also comprises a storage module 55 configured to store one or more data items received in response to the sent extraction law(s) into the class of the structured database 10 corresponding to a first identifier of a class of the extraction rule, the extraction rule comprising the extraction law that produced the or the data item(s).

The storage of each data item in the respective class is understood here as synonymous with an indexing, or even a ranking, of said data item in said class.

The generation device 25 comprises an association module 60 configured to associate each sent extraction law, to a class of unsuccessful queries in the absence of a response to said law, from the set 15.

As an optional addition, the generation device 25 comprises a retrieval module 65 configured to retrieve a request for data on behalf of the user 47, a determination module 70 configured to determine whether or not each requested data is present in the structured database 10, and a communication module 75 configured to communicate a message based on that which is determined by the determination module 70.

In the example of FIG. 1, the generation device 25 comprises an information processing unit 80 formed by, for example, a memory 85 and a processor 90 associated with the memory 85.

In this example of FIG. 1, the acquisition module 35, the generation module 40, the selection module 45, the sending module 50, the storage module 55, the association module 60, as well as optionally the retrieval module 65, the determination module 70 and the communication module 75, are each realized in the form of a software program, or a software brick, and executable by the processor 90. The memory 85 of the generation device 25 is then able to store software for acquiring the list of required actions and the group of extraction rules, software for generating a structure of the structured base 10, software for selecting the extraction rules from the required action chosen by the user 47, software for sending the extraction law included in each selected extraction rule, software for storing in the structured database 10 the or each extracted data received, in the class corresponding to the first identifier associated with the extraction law in response to which each data was received, and software for associating, in the absence of extracted data received in response to a respective sent extraction law, said extraction law to the class of unsuccessful queries of the structured database 10. As an optional addition, the memory 85 of the generation device 25 comprises software for retrieving the request for data from the user 47, software for determining whether each requested data is present in the structured base 10, and software for communicating the message from that which is determined by the determination software.

In FIG. 1, the software bricks are linked by arrows, each typically representing a function call.

In a variant not shown, the acquisition module 35, the generation module 40, the selection module 45, the sending module 50, the storage module 55, the association module 60, as well as optionally the recovery module 65, the determination module 70 and the communication module 75, are each realized in the form of a programmable logic component, such as an FPGA (Field Programmable Gate Array), or of an integrated circuit, such as an ASIC (Application Specific Integrated Circuit).

When the generation device 25 is implemented as one or more software program(s), in other words, as a computer program, it is further able to be recorded on a computer-readable medium, not shown. The computer-readable medium is, for example, a medium capable of storing electronic instructions and of being coupled to a bus of a computer system. For example, the readable medium is an optical disk, a magneto-optical disk, a ROM memory, a RAM memory, any type of non-volatile memory (for example, EPROM, EEPROM, FLASH, NVRAM), a magnetic card or an optical card. On the readable medium is then stored a computer program comprising software instructions.

Each extraction rule comprises a respective extraction law and a respective first identifier of a class.

Each extraction law comprises all the keyword(s), and at least one specificity specifying respectively a characteristic of each keyword or a dependency of several keywords, where appropriate. Each extraction law is for example a textual element forming a sentence in a natural language, each specificity being, if applicable, a textual expression semantically linking the keywords. Alternatively, each extraction law is in the form of a graph in which each keyword represents a node, and each specific dependency being represented by an arc connecting two nodes in the case where the graph comprises several nodes.

In the case where the extraction law is a textual element forming a sentence in a natural language, NLU techniques (from the English Natural Language Understanding) allow to identify the keywords. These NLU techniques are artificial intelligence techniques, based on a computer model of keyword prediction. These models are trained on a set of input text corpus, for which an expected keyword is provided as output.

Each source base 20 comprises a set of data, each of which can be extracted from the source base 20, following a query in a computer language that can be interpreted by the source base 20.

Each source base 20 having its own structure and its own language, the translator 30 specific to each source base 20 is configured to translate a respective extraction law expressed in a so-called natural language, into a respective query expressed in the language of the source base 20 or in a language interpretable by the source base 20.

A natural language is understood here to mean a written or spoken language, which is not a computer language. Thus, the French, English and German languages are non-exhaustive examples of natural languages.

The computer language in which the extraction laws are translated into respective queries is, for example, the so-called SPARQL language (SPARQL Protocol and RDF Query Language).

Each translator 30 is configured to generate, from the received extraction law, the query including at least one second identifier of a class and at least one extraction criterion.

Each second identifier of a class, also called argument, corresponds to a respective class of the source base 20, and then allows to identify such a class. In each computer query in SPARQL language, the second identifiers are of a class, for example, marked by a first name “SELECT” preceding the second identifier.

Each extraction criterion, also called condition, relating to a discriminating characteristic concerning the data of the class identified by a respective second identifier. Thus, only the data verifying each extraction criterion are extracted. In each SPARQL query, each extraction criterion is marked by a second name “WHERE” preceding said criterion.

In other words, each SPARQL query is able to extract, from the source base 20, the data corresponding to each second identifier of a class marked by the first name “SELECT” and verifying each extraction criterion, each extraction criterion relating to at least one second identifier of a class.

A specificity of the SPARQL language is that it is not necessary to introduce before the second name “WHERE”, each second identifier of a class on which a respective extraction criterion applies.

As an example, the translator 30 is of the SPARQL type, specific to a respective source base 20 including the classes “aerodrome” and “runway”, and is configured to translate the extraction law “Find an airport the runway length of which is greater than 1.2 km” into a respective SPARQL query including the second identifier of a class “aerodrome” in the form “SELECT aerodrome”, and including the extraction criterion in the form “WHERE {runway ≥1.2 km}”. Only the datum or the data, corresponding to the class identified by the second identifier “aerodrome” and for which the class, identified by the second identifier “runway”, includes runways greater than 1.2 km, is extracted by the SPARQL query.

The translator 30 is known per se, as the SWIP project proposes such a translator 30 in particular. The translator 30 of the SWIP project is able to translate a respective extraction law expressed in natural language, into a respective SPARQL query, through an Automatic Natural Language Processing process called “NLP”.

In addition, computer languages other than SPARQL, such as “SPARQL-DL”, “Snap SPARQL”, “OWL-QL”, “SQWRL”, or even “DL-Query”, are also suitable for data extraction.

According to the above-mentioned example in which the task is the flight of an aircraft, the set 15 comprises for example at least one of the following source bases 20:
“ATM Information Reference Model Ontology” (known as AIRM-O) for air traffic,
“Aeronautical Information exchange Model” (AIXM) for the management and distribution of aeronautical information services data, or
“ICAO Meteorological Information Exchange Model” (IWXXM) for meteorological data.

The acquisition module 35 is configured to acquire the list of required actions during the task. Each required action designates an intention of the user 47 during the task. This intention is referred to as a high level intention, as opposed to a decision made by the user 47 after consulting the relevant data. Thus, the relevant data for making the decision depends, at least in part, on the chosen required action, that is, the chosen intention.

In the above example where the task is the flight of the aircraft, the list of required actions comprises, for example: a start of the aircraft, a diversion of the aircraft, and a bypassing by the aircraft of a geographical area.

The acquisition module 35 is also configured to acquire the group of extraction rules. Each extraction rule is associated with the required action from the list of required actions. Thus, each required action allows filtering of the data that will be extracted by the extraction law included in each extraction rule associated with said action.

In the above example where the task is the flight of an aircraft, and with the above example of the list of required actions, the group of extraction rules typically includes the extraction rules associated with the action of diverting the aircraft, the extraction law of each of which is, for example, the following:
find an airport with a runway length greater than a predefined length,
find an airport with emergency services, and
find an airport that is at most a first predefined maximum distance D₁ₘₐₓ away from the aircraft.

In the case of the first extraction law mentioned above, the keywords are for example, “airport” and “runway”.

In this example, the list of extraction rules typically includes the extraction rules, associated with the action of the aircraft bypassing a geographical area, the extraction law of which for each is for example:
find the coordinates of waypoints of the aircraft for which the weather conditions correspond to predefined conditions, and distant from the aircraft by at most a second predefined maximum distance D₂ₘₐₓ, and
find the coordinates of the waypoints of the aircraft for which an internet coverage of a satellite technology is available.

Alternatively, the task is the monitoring of patients in a hospital. A respective required action is then, for example, to detect patients at risk of COVID-19 in an emergency department. The extraction rules are then, for example, the following:
select all patients in the emergency department who have not been diagnosed with COVID-19 and are older than 60 years,
select patients in the emergency department who have not been diagnosed with COVID-19 and who are at cardiovascular risk,
select emergency department patients who have not been diagnosed with COVID-19 and have shared a room with a patient with COVID-19,
select patients from the hospital the age of whom is in a predefined range, such as 30-50 years.

As another alternative, the task is to control a fire. The required action is then to determine the appropriate means for the management of this fire. The extraction rules are then for example:
determine the emergency vehicles with fire extinguishing services,
determine the emergency vehicles equipped with a minimum of one driver, one certified chief and four crew members, and
determine the emergency vehicles present in the accident area.

As another alternative, the task is the management of accidents by an EMS service. A respective required action is then the search of hospitals to take care of a victim, following an accident. An extraction rule is then to determine the hospitals having a service adapted to a pathology of a victim to be taken in charge.

The first identifier of a class included in each extraction rule corresponds to the class of the structured database 10 in which each extracted data should be stored after the sending of the respective extraction rule. More detailed explanations of the classes of the structured database 10 are provided below.

The acquisition module 35 is also optionally configured to acquire a set of invariant data during the task. The set(s) of invariant data comprise, if applicable, data that does not change during the task and is known prior to the task, as well as the first identifier of a class associated with each of said data for storing said data in the structured database 10. The set of invariant data also comprises data that is not present in the set 15, allowing the extraction laws to be completed.

In the above example where the task is the flight of an aircraft, the invariant data comprises, for example: a type or reference of the aircraft, an initial amount of fuel in the aircraft, a task flight number, and a departure airport of the aircraft.

The generation module 40 is connected to the output of the acquisition module 35, and is configured to generate the structure of the structured base 10. The structure of the structured base 10 includes classes, and in particular a respective class for each first identifier of a class of the group of extraction rules.

Optionally, each first identifier of a class is selected from among the following six class names: “subject”, “tool(s)”, “community”, “rule(s)”, “division of labor”, “target”. This decomposition into six classes is known in itself, and comes from the activity theory proposed by Y. Engeström in 1987 in the document “Learning by expanding: An activity-theoretical approach to developmental research, Helsinki: Orienta-Konsultit”. This decomposition is a generic structure allowing to describe in an exhaustive manner a set of elements necessary for an activity while ensuring an objective distinction between the classes.

If the classes are the six classes related to the activity theory, the skilled person will observe that the class “rules” refers to the business rules to be applied for the realization of an objective. These business rules correspond to the extraction rules.

The generation module 40 is also configured to generate the class of unsuccessful queries in the structured database 10.

The selection module 45 is connected to the output of the acquisition module 35, and is configured to select at least one respective extraction rule from the group of extraction rules.

Depending on the required action chosen by the user 47 from among the list of required actions, the selection module 45 is configured to select, from the group of extraction rules, each rule associated with said chosen action.

If the chosen required action is diversion of the aircraft, the selection module 45 is configured to choose the extraction rules associated with the action of diversion of the aircraft, such as those described above. As a corollary, if the selected required action is bypass of the aircraft, the selection module 45 is configured to select the extraction rules that are associated with that required action.

The sending module 50 is connected to the output of the selection module, and is configured to send, to the set 15, the extraction law for each selected extraction rule.

In the case where the set 15 comprises several source bases 20, the sending module 50 is configured to send the extraction law included in each selected extraction rule, to each source base 20, via the translator 30 specific to said source base 20.

The sending module 50 is optionally configured to complete before sending, and if applicable, a respective extraction law from the data already stored in the structured database 10.

For example, for the extraction law expressed as the textual expression “find an airport with a runway length greater than a predefined length”, the predefined length is preferably automatically completed based on the invariant data corresponding to the type or reference of the aircraft.

The storage module 55 is connected to the output of the selection module 45, and is configured to receive and store, in the structured base 10, an element or elements of the message or messages received in response to the extraction law or laws sent to the set 15. Each received message comprises, for example, the following elements: a set of extracted data, a set of second identifiers of a class, and a set of extraction criteria.

Specifically, each received message comprises a data field including two tables. A first table comprises the extracted dataset. A second table comprises the SPARQL query that allowed the extraction of the extracted dataset. The set of second identifiers of a class and the set of extraction criteria are then included in the second table.

The storage module 55 is configured to store each extracted dataset, each set of second identifiers, and each group of extraction criteria into the class corresponding to the first identifier associated with the extraction law at the origin of the received data.

Each extracted data corresponds to a respective data of a source base 20 in response to the sent extraction law.

As an optional addition, the storage module 55 is configured to store, in the structured database 10, at least a first relationship between a respective extracted data and a respective second identifier, or between an extracted data and a respective extraction criterion. The storage module 55 is preferably configured to store, in the appropriate class, each first relationship defining a link between two stored elements.

Each first relationship is, for example, a textual element, also known as an axiom or semantic data triplet. Each first relationship defines the semantic link between two elements stored in the structured database 10. Each semantic link allows, for example, to define a link of membership, interdependence, or hierarchy between two elements. Such a hierarchy link is comparable to a notion of sub-class. Thus, for example, the semantic link between an extracted data item “Bordeaux” and a second identifier “airport”, of the type “Bordeaux is an airport” is equivalent to having in the structured database 10, the sub-class “airport” comprised in one of the classes, for example, resulting from the activity theory, and comprising the extracted data item “Bordeaux”. Such semantic links thus allow to qualify the structured database 10 as an ontologically organized base, because it comprises, in addition to data, semantic links between its data. Such a formalism of an ontologically organized base is said to be of the OWL type (from the English Ontology Web Language or Web Ontology Language).

The above details concerning each first relationship are also applicable to each second, third and fourth relationships defined hereafter. Each first relationship is deduced from the extraction law included in the extraction rule to which it is related, and in particular from the specificities of dependence between each keyword in the said law.

As an optional addition, the storage module 55 is configured to, in the event of receiving multiple extracted data following the sending of a respective extraction law, store each extracted data received in the structured database 10. Thus, in the case where the set 15 comprises at least two source bases 20, if the extracted data is received from several source bases 20, each extracted data is stored in the class corresponding to the first identifier associated with the extraction law at the origin of the received extracted data.

As a further optional addition, the storage module 55 is configured to, if at least two received second identifiers are associated with the same respective keyword of the extraction law, store a second relationship in the structured database 10. The second relationship then indicates, for example, that the two second identifiers are synonymous.

As an optional addition, the storage module 55 is also configured to store the invariant data during the task into the classes associated with the first identifier of each, if all the invariant data has been acquired.

As a further optional addition, the storage module 55 is also configured to store the group of extraction rules in the “rules” class, if the structured database 10 comprises such a class. The association module 60 is connected to the output of the selection module 45 and to the output of the set 15 of the source bases 20. The association module 60 is configured to associate each extraction law, for which no extracted data is received, with the unsuccessful queries class.

The association module 60 is optionally configured to determine that no extracted data is received following the sending of a respective extraction law if the or the message(s) received from the set 15 only verify at least one of the following:
an error message is received from set 15,
a message including an empty data field is received from the set 15.
   The association module 60 is configured to receive SPARQL language queries as output from each translator 30.

Thus, the association module 60 is configured to receive from the set 15, for each source base 20 and for each extraction law sent, the set of second identifiers of a class, and the group of extraction criteria.

The set of second identifiers of a class and the group of extraction criteria are obtained by the translator 30 specific to each source base 20.

In the absence of receiving extracted data following the or each extraction law sent, the association module 60 is optionally configured to label the sent law as unsuccessful. The association module 60 is then preferably configured to associate each unsuccessful law with the class of unsuccessful queries by storing in said class, the set of second identifiers and the group of extraction criteria associated with said law.

An extraction law without response of an extracted set of data, that is, for which the first table of the received message is empty, is considered as unsuccessful. This mechanism refers to an absence of the searched data in the set 15 of source bases 20. These data are also referred to as missing data.

More specifically, for each unsuccessful law, the association module 60 is optionally configured to store, in the class of unsuccessful queries: each second identifier absent from the structured base 10, each extraction criterion, and at least one third relationship linking a respective second identifier and a respective extraction criterion of the unsuccessful law. The association module 60 is preferably configured to store, for each unsuccessful law, each third relationship linking two elements stored by said module 60 and each third relationship linking a respective second identifier already present in the structured base 10 to another respective element stored by said module 60.

As an optional complement, the association module 60 is optionally configured to, in the event that an extraction law is qualified as unsuccessful, distinguish the relevant configuration from among the first and second possible configurations.

In the first configuration, no extracted data is received because no data verifies the group of extraction criteria. The association module 60 is configured to perform the storing as described above in this case.

In the second configuration, no data is received because no source base 20 includes the set of classes corresponding to the set of keywords of the extraction law qualified as unsuccessful. In other words, the translator 30 of each source base 20 has failed to translate each keyword of the extraction law into a second identifier of a class of the source base 20 with which it is associated. The association module 60 is, in this case, configured to, store in the class of unsuccessful queries, each second identifier absent from the structured base 10, each keyword of the unsuccessful law having no associated second identifier, each extraction criterion and at least a fourth relationship linking said one or more keywords to a second identifier of the unsuccessful law. For each extraction criterion specifying a feature of a keyword not translated into a second identifier, the second identifier is replaced by said keyword. The association module 60 is preferably configured to store, for each unsuccessful extraction law, all fourth relationships existing between each second identifier, each keyword, and each extraction criterion, taken two by two.

The retrieval module 65 is configured to retrieve a data request from the user 47. The retrieval module 65 is configured, for example, to retrieve the request in textual form.

The communication module 75 is connected to the output of the determination module 70 and is configured to communicate the message from what has been determined by the determination module 70, to the user 47 or to an electronic processing device, not shown.

For this purpose, the communication module is, for example, a virtual assistant comprising a chatbot interacting with the user 47 through communication means such as a display screen, an audio system comprising a microphone and/or a speaker, a haptic sensor and/or actuator, or any possible combination of the aforementioned communication means.

The communication module 75 is configured to communicate each requested data item present in the structured base 10 to the user 47 or to the electronic processing device. The communication module 75 is also configured to, if the request relates to a respective second identifier of a class, or if applicable, a respective keyword of the unsuccessful query class, communicate a message indicating that the requested data relates to data absent from the set 15 of source bases 20 to the user 47 or to the electronic processing device.

As an optional addition, the communication module 75 is also configured to, if the requested data is absent from the structured database 10 and does not relate to a respective second identifier or keyword of the class of unsuccessful queries, communicate a respective message indicating that the requested data has not yet been searched, to the user 47 or the electronic processing device. The communication module 75 is in this case, typically further configured to send the request to the set 15 as an extraction law to attempt to obtain the requested data.

Thus, each requested action corresponds to the intent of the user 47 during the task for which data is being retrieved to assist in making a decision.

Each extraction rule is associated with the required action, and comprises the specific extraction law to be sent to the set 15, as well as the first identifier of the class.

Each extraction law comprises the set of keywords and at least the specificity specifying the characteristic of said keyword, or if necessary, the dependency between two keywords.

The first identifier of the class corresponds to the class of the structured database 10 in which the data from the set 15 are stored, following the sending of the extraction law.

The invariant data includes data that does not change during the task and the first identifier of the class, specific to each data item, indicating the class of the structured database 10 in which said data item is to be stored.

Each class is the element of the structure of the structured database 10 corresponding to the first identifier of the class included in the extraction rule.

The structured base 10 also comprises the class of unsuccessful queries.

Each query corresponds to the translation by the translator 30 of the extraction law. Each query comprises the respective set of second identifiers and the respective set of extraction criteria.

Each second identifier of the class corresponds to the translation, by the translator 30 of a respective keyword of the extraction law. Each second identifier of the class, identifies the respective class of the source base 20 to which the translator 30 is associated.

Each extraction criterion corresponds to the translation by the translator 30, of the specificity in the condition for extracting data from the source base 20 with which the translator 30 is associated.

Each message received from the set 15 comprises the set of second identifiers of the class, the group of extraction criteria, and if applicable, the set of extracted data.

Each extracted data is the data from the respective source base 20 extracted by the query.

Each first relationship corresponds to the link, stored in the structured database 10, between the extracted data and the second identifier of the class of the associated query, or between the extracted data and the extraction criterion of said query, or between the second identifier and the extraction criterion, or even between two second identifiers, if applicable.

Each second relationship corresponds to the link, stored in the structured database 10, between two second identifiers of a class specifying that they are synonyms, in the case where the two second identifiers are associated with the same respective keyword.

Each third relationship corresponds to the link, stored in the structured database 10, between the respective second identifier and the respective extraction criterion of said query, or if applicable, between two second identifiers of a respective query, in the absence of data extracted by said query.

Each fourth relationship corresponds to the link, stored in the structured database 10, between a respective second identifier or a respective keyword, and another respective second identifier or another respective keyword or even an extraction criterion, each of the same respective query, in case of absence of translation of a keyword into a respective second identifier of the class.

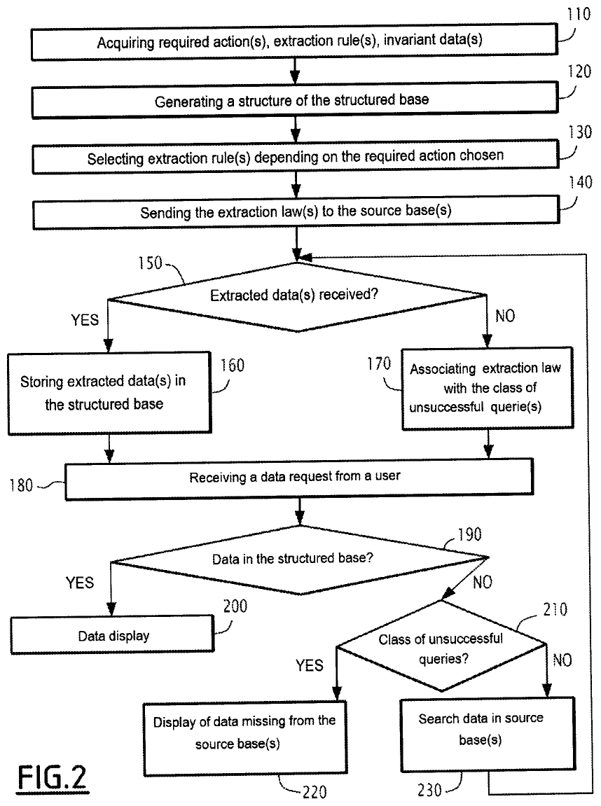

The operation of the generation system 5, and in particular of the generation device 25 according to the invention, will now be described with respect to FIG. 2 representing a flow chart of the method, according to the invention, of generating the structured base 10, the method being implemented by the generation device 25.

During an acquisition step 110, the generation device 25 acquires the list of action(s) required during the task and the group of data extraction rules of the set 15, via its acquisition module 35. Each extraction rule is associated with a respective required action.

In the acquisition step 110, the generation device 25 optionally further acquires the sets of invariant data during the task.

The generation device 25 then proceeds to a generation step 120 in which it generates the structure of the structured base 10, via its generation module 40.

During the generation step 120, the generation device 25 optionally stores the set of invariant data in the classes of the structured database 10, as well as the group of extraction rule(s) in the class “rule(s)” if such a class is present.

The generation device 25 then proceeds to a selection step 130 in which it selects, following the choice by the user 47 of the required action from among the list of required actions, the or the extraction rule(s) associated with the chosen required action.

The generation device 25 then proceeds to a sending step 140 in which, it sends via its sending module 50, each selected extraction law to the set 15. In the event that the set 15 includes multiple source bases 20, the sending module 50 sends the extraction law included in each selected extraction rule, to each translator 30 of each source base 20.

As an optional addition, during the sending step 140, the generation device 25 completes the extraction laws from data already stored in the structured database 10.

The generation device 25 then proceeds to a first detection step 150, in which it receives, for each extraction law sent, a message from the set 15, and detects whether or not the set of extracted data is present in the received message.

For each received message comprising the set of extracted data, the generation device 25 stores, during a storage step 160 and via its storage module 55, each received extracted data in the structured database 10.

As previously described for the storage module 55, during the storage step 160, the generation device 25 stores in the class corresponding to the first identifier associated with the extraction law, in response to which the retrieved data is received, each second identifier still absent from the structured base 10, each extraction criterion, each extracted data, and at least one respective first relationship between a respective extracted data and a respective second identifier. During the storage step 160, the generation device 25 preferably stores all first relationships between the extracted data, the second identifiers, and the extraction criteria.

As an optional addition, during the storage step 160, in the event that at least two extracted data are received in response to the same sent extraction law, the generation device 25 stores each received extracted data into the class corresponding to the first identifier associated with said extraction law.

As a further optional addition, during the storage step 160, in the event that the set 15 comprises at least two source bases 20, if two second identifiers associated with the same respective keyword of the extraction law are received, the generation device 25 stores a respective second relationship in the class corresponding to the first identifier of the rule associated with said law.

For each message received that does not comprise an extracted set of data, the generation device 25 proceeds to an association step 170 in which it associates the extraction law at the origin of said message, with the class of unsuccessful queries.

As an optional addition, during the association step 170, the generation device 25 labels said law as unsuccessful. The generation device 25 stores in the class of unsuccessful queries, each second identifier absent from the structured database 10, each extraction criterion, and at least one respective third relationship linking two second identifiers together or linking a respective second identifier to a respective extraction criterion. The generating device 25 preferably stores all the third relationships between each second identifier and each extraction criterion.

As a further optional addition, during the association step 170, if the absence of extracted data is due to the absence of translation of a respective keyword of the sent law into a respective second identifier of a respective source base 20, then the generation device 25 stores, in the class of unsuccessful queries: each second identifier of the class absent from the structured base 10, each keyword not translated into a respective second identifier, each extraction criterion, at least one respective fourth relationship linking a respective second identifier or a respective keyword, to a respective extraction criterion or to a respective second identifier or to a respective keyword. For each extraction criterion relating to each keyword not translated into a respective second identifier, the keyword replaces the second identifier. During the association step 170, each fourth relationship linking two stored elements is preferably also stored in the structured base 170.

According to a variant not shown in FIG. 2, the generation device 25 repeats the sending 140, storing 160, and associating 170 steps regularly, and preferably periodically, for updating the data in the structured base 10.

The generation device 25 then optionally proceeds to a retrieval step 180 during which it retrieves, via its retrieval module 65, the request for data from the user 47.

The generation device 25 then passes into a determination step 190 in which it determines, via its determination module 70, whether or not each requested data is contained in the structured database 10.

For each requested data item, if said data item is contained in the structured database 10, the generation device 25 then proceeds to a first communication step 200 during which it communicates, via its communication module 75, the requested data item to the user 47 or to the electronic processing device.

For each requested data item absent from the structured database 10, the generation device 25 proceeds to a second detection step 210 in which it detects whether the request relates to the element(s) stored in the class of unsuccessful queries by detecting whether the request is associated with a respective second identifier, a respective extraction criterion, a respective third or even fourth relationship of the class of unsuccessful queries.

If the request is related to an element or elements of the class of unsuccessful queries, the generation device 25 proceeds to a second communication step 220 in which it communicates a message indicating that the requested data is missing from the set 15, to the user 47 or to the electronic processing device.

If the request is not related to an element or elements of the class of unsuccessful queries, the generation device 25 optionally proceeds to a third communication step 230 in which it communicates a message indicating that the requested datum or data have not yet been searched for to the user 47 or to the processing device.

During the third communication step 230, the generation device 25 optionally sends the request to the set 15 and returns to the storing step 160 if a respective retrieved data is received back. Otherwise, the generation device 25 proceeds to the association step 170. In the event that extracted data is received back, the storage module 55 stores the different elements into a class of the structured database 10 selected by the user 47.

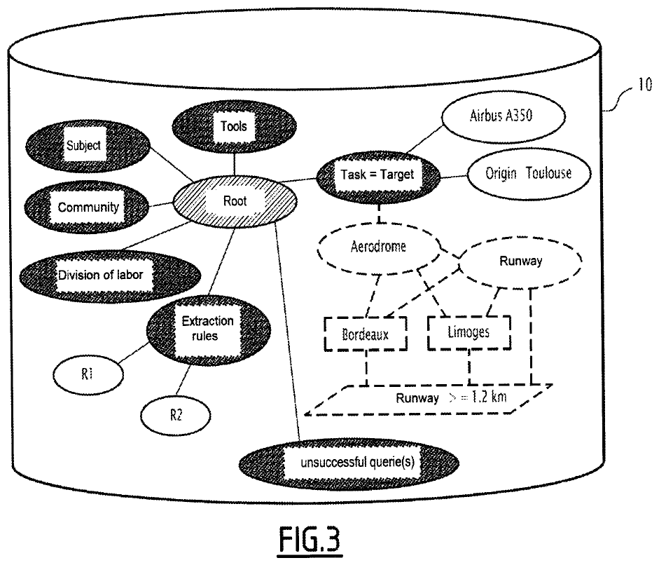

The operation of the generation system 5, and more precisely of the generation device 25, will now be illustrated, with reference to FIGS. 2 and 3, on an example of an aircraft flight task.

During the acquisition step 110, the required action is for example the diversion of the aircraft.

During the acquisition step 110, the generation device 25 acquires the extraction rules, linked to the required action of diverting the aircraft, the extraction laws of which are respectively: “find an airport the runway length of which is greater than a predetermined length L”, and “find an airport the weather conditions of which correspond to the CAVOK standard, and distant from the aircraft by no more than 50 km”, CAVOK (from the English “Cloud And Visibility OK”) corresponding to a meteorological standard in which visibility is considered good and in which the presence of clouds is limited. The first identifier contained in each of these extraction rules is “task”.

For the first extraction law, the keywords are: “airport” and “runway”. For the second extraction law, the keywords are: “airport”, “weather conditions” and “distance”.

During the acquisition step 110, the acquisition module 35 also acquires the invariant data relating to the aircraft model reference, for example “Airbus A350”, and to the airport of origin “airport of origin Toulouse”, each invariant data being associated with the first identifier of the class “task”.

During the generation step 120, the generation device 25 generates the structure of the structured database 10. The structure must at least include the “task” class, as it corresponds to the first identifier of the class of the acquired extraction rules. For example, the structure comprises the six classes of activity theory: “subject”, “tool(s)”, “community”, “division of labor”, “aim”, and “rule(s)”.

In this example, the class “task” then corresponds to the class “aim”, so that the classes “aim” and “task” form one and the same class.

Also in this example, the “subject” class is intended to contain data relating to the pilot of the aircraft, the “tool(s)” class is intended to contain data relating to the means to carry out the task, the “community” class is intended to contain data relating to other entities or individuals who will participate in the course of the task such as the co-pilot, the personnel onboard, or to the control towers, the “division of work” class is intended to contain data relative to the sharing of the activity with the community, and the “target” class is intended to contain data relative to the task.

The generated structure further comprises the class of unsuccessful queries, called “unsuccessful queries”.

In FIG. 3 the classes are shown as shaded boxes each attached to the root which is shown as a hatched box.

During the generation step 120, the generation device 25 stores the invariant data into the class indicated by its first identifier of the class.

During the generation step 120, the generation device 25 stores the extraction rules in the class “rule(s)”. In FIG. 3, the extraction rules are referenced as R₁ and R₂, respectively.

During the selection step 130, the generation device 25 selects the extraction rules associated with the required action “divert aircraft” chosen by the user 47.

During the sending step 140, the generation device 25 completes the extraction law of the first extraction rule with the invariant data relating to the aircraft model reference stored in the structured database 10. The extraction law of the first extraction rule thus becomes, for example, “find an airport with a runway length greater than 1.2 km”.

During the sending step 140, the generating device 25 sends, to the set 15, the extraction laws contained in the first and second extraction rules.

During the first detection step 150, the generation device 25 receives a message from the set 15 for each law sent and detects the presence or absence of the set of extracted data. A first (respectively second) message corresponds to the message received following the sending of the extraction law included in the first (respectively second) extraction rule.

The first message comprises for example the second identifiers: “aerodrome” and “runway”, the extraction criterion “runway ≥1.2 km” and the set of extracted data “Bordeaux, Limoges”

The second message comprises, for example, the second identifiers “aerodrome” and “weather”, and “distance”, the extraction criteria “weather=CAVOK” and “distance ≤50 km”, but no set of extracted data.

For the first message, during the storage step 160, the generation device 25 stores, in the “task” class of the structured database 10, the second identifiers, the extraction criterion, and the extracted data. In FIG. 3, the second identifiers, the extraction criterion, and the extracted data are respectively represented by dotted line boxes, respectively elliptical, parallelepipedal, and rectangular in shape.

During the storage step 160, the generation device 25 stores in the structured database 10, the first relationship: “aerodrome includes runway”, “Limoges is an aerodrome”, “Bordeaux is an aerodrome”, “Limoges includes runway”, “Bordeaux includes runway”, “runway ≥1.2 km is a type of runway”, “Limoges includes runway ≥1.2 km” and “Bordeaux includes runway ≥1.2 km”. In FIG. 3, these first relationships are represented by dashed line segments each connecting two boxes.

For the second message, during the association step, 170, the generation device 25 qualifies the extraction law as unsuccessful and stores in the class “unsuccessful queries”, the second identifiers “weather” and “distance”, as well as the extraction criteria “weather=CAVOK” and “distance ≤50 km”. The second identifier “aerodrome” is not stored in the unsuccessful queries class because it is already present in the “task” class.

The generation device 25 stores, also in the structured base 10, the third relationships: “aerodrome includes weather”, “aerodrome is at distance” “distance ≤50 km is a distance type”, “weather=CAVOK is a weather type”

For the sake of readability of the drawings, the elements stored in the association step 170 are not shown in FIG. 3.

During the retrieval step 180, the generation device 25 retrieves the following first and second requests from the user 47: “Which airports have a runway that is at least 1 km long?” and “Which airports have CAVOK weather and are less than 30 km away from the aircraft?”

During the determination step 190, the generation device 25 determines that the first request is related to extracted data present in the structured database 10, unlike the second request.

For the first request, during the first communication step 200, the generation device 25 communicates the data “Bordeaux” and “Limoges” to the user 47.

For the second request, the generation device 25 proceeds to the second detection step 210 in which it detects that the second request is related to the class “unsuccessful queries” because if the set 15 does not include any data verifying the extraction criterion related to the weather conditions and being at a distance of less than 50 km from the aircraft, then the set 15 does not include any data verifying the same criterion on the weather conditions and being at a distance of at most 30 km.

During the second communication step 220, the generation device 25 communicates to the user 47 a message indicating that the requested data is absent from the set 15.

The generation method according to the invention then allows the structured base 10 to be generated comprising a smaller number of data, each data item in the structured base 10 corresponding to a respective extraction rule.

Furthermore, the storage in the structured base 10 of second identifiers of the class, extraction criteria, first relationships, second relationships, third relationships and fourth relationships allows for contextualization of each extracted data and therefore a better use of the extracted data. The said elements are classified context elements. Indeed, this allows a user to have access not only to the data, but also to the context in which they were extracted, and thus to better understand the origin of each data. This allows, among other things, a user 47 to detect a possible inconsistency of data extracted from a source base 20, which would be impossible, or at least more difficult, without said context elements.

Furthermore, the storage of each of the above mentioned context elements, combined with the structure resulting from the activity theory, allows the generation of a dedicated and exhaustive structured database 10, from a generic method applicable to different domains.

Moreover, the selection of extraction rules depending on the required action chosen by the user 47 makes the extraction more selective, ensuring that the extracted data are useful for the understanding of the situation.

In addition, the class of unsuccessful queries allows to distinguish from among the data that is absent, in the structured database 10, that which is assumed to be irrelevant when establishing the extraction rule(s), and that which is absent from the source base(s) 20.

The optional retrieval 180, determination 190, and communication 200 steps allow to communicate the data in the structured database 10 to the user 47 and, thanks to the class of unsuccessful queries and association step 170, to furthermore inform the user 47 more quickly as to any data that is absent from the set 15. Taking into account the absence of certain data from the set 15 then leads to a better understanding on the part of the user 47 of the data that is at their disposal in the structured database 10.

Moreover, the fact that in case of a request concerning neither a data contained in the structured base 10, nor an element of the class of unsuccessful queries, this request is, nevertheless, preferably taken into account to query the set 15, and allows the user 47 not to be constrained by the only data considered relevant by the group of extraction rules.

The fact that the extraction rules are sent to the set 15 in a so-called natural language, and that the translation into computer language is performed by the respective translator 30, makes the method more easily adaptable to different heterogeneous source bases 20. In particular, it is easier to add one or more source bases 20 to the set 15.

In addition, the fact that when distinct data is received in response to the same extraction law, the distinct retrieved data is stored, during the storage step 160, in the same class of the structured database 10, allowing the validation of the retrieved data to be left to the user 47. This also avoids the risk of omitting the storage of relevant data in the structured database 10.

It is thus conceived that the generation method and device 25 according to the invention allow for improved data extraction from the or the source base(s) 20, as well as the generation of the structured base 10 that optimizes the response times to the queries of the user 47.

1. A method for generating, from a set of databases, a structured database associated with a task, the method being implemented by an electronic generation device and comprising:
acquiring a list of required action(s) during the task, and a group of data extraction rules from the set of databases, each extraction rule including a first identifier of a class of the structured database and a law for extracting data from the set of databases, each rule being associated with one or more required action(s);
generating a structure of the structured database including at least one class for each first identifier of a distinct class, and a class of unsuccessful queries;
selecting of the extraction rule(s) from among the acquired group of extraction rules based on a required action selected by a user from among the list of required, action(s);
sending the extraction law included in each selected extraction rule to the set of databases, and receiving the extracted data from the databases as a result of that sending;
storing the or each received extracted data in the class of the structured database corresponding to the first identifier of the class associated with the extraction law in response to which the data was received; and
for each extraction law sent, if no extraction data is received in response from the set of databases, associating the law with the class of unsuccessful queries.

2. The method according to claim 1, wherein, following said sending, no extracted data is received from the set of databases if the or each message(s) received from the set of databases only verify at least one of the following:
an error message is received from the set of databases; and
a message including an empty data field is received from the set of databases.

3. The method according to claim 1, wherein the set of databases comprises at least two databases, and during said sending, the extraction law included in each selected extraction rule is sent to each database.

4. The method according to claim 3, wherein if the databases provide at least two different extracted data in response to a same sent extraction law, the at least two extracted data are, during said storage, stored in the same class of the structured database, corresponding to the first identifier of the class associated with the extraction law.

5. The method according to claim 1, wherein following said sending, each received data comprises:
a set of data extracted from a database, in response to the sent extraction law;
a set of second identifier(s) of the class of the database from which the set of extracted data originated, each second identifier corresponding to a respective class of the database from which at least one respective set of extracted data originated; and
a group of data extraction criteria from the database from which the set of extracted data is derived,
wherein the set of second identifier(s) and the group of criteria are specific to each database and are generated from the sent extraction law,
wherein during said storage, the set of second identifier(s), the group of criteria and the set of data are stored in the class corresponding to the first identifier of the class associated with the extraction law, and
wherein during said storage, at least one first relationship between an extracted data and a second identifier of the class is further stored in the class of the structured database.

6. The method according to claim 1, wherein the task is flying an aircraft.

7. The method according to claim 6, wherein the extraction rules associated with the required action of diverting comprise the extraction laws:
find an airport with a runway length greater than a predefined length;
find an airport with weather conditions corresponding to predefined conditions;
find an airport with emergency services; and
find an airport that is at most a predefined maximum distance from the aircraft,
and wherein the extraction rules associated with the required bypass action comprise the extraction law:
find coordinates of the aircraft waypoints for which the weather conditions correspond to predefined conditions, and distant from the aircraft by at most a second predefined maximum distance.

8. The method according to claim 1, wherein during said acquisition, invariant data during the course of the task is additionally acquired, and during said sending, at least one sent extraction law is completed by at least one invariant data of the task.

9. The method according to claim 1, further comprising, after said storage or said association:
retrieving a request from a user, and
if the request is related to an extraction law associated with the class of unsuccessful queries, communicating a message to the user indicating that the data responding to the request is missing from the set of databases.

10. A computer program comprising software instructions which, when executed by a computer, cause the computer to implement a method according to claim 1.

11. An electronic generation device configured to generate, from a set of databases, a structured database associated with a task, the electronic generation device being connected to the set of databases (20), the electronic generation device comprising:
an acquisition module configured to acquire a list of required actions during the task, and a group of data extraction rules from the set of databases, each extraction rule including a first identifier of a class of the structured database and a law for extracting data from the or each database, each rule being associated with one or more required action(s);
a generation module generating a structure of the structured database including at least one class for each distinct first identifier of a class, and a class of unsuccessful queries;
a selection module selecting one or more extraction rules from the acquired group of extraction rules, depending on a required action chosen by a user from among the list of required actions;
a sending module sending the extraction law included in each selected extraction rule to the set of databases;
a module for receiving data from the databases following this sending;
a storage module storing each received data in the class of the structured database corresponding to the first identifier of the class associated with the extraction law in response to which the data was received; and
an association module associating each sent extraction law, for which no extracted data is received in response from the set of databases, with the class of unsuccessful queries.

12. The method according to claim 6, wherein the set of required actions comprises a start of the aircraft, a diversion of the aircraft, and a bypassing by the aircraft of a geographical area.

13. The method according to claim 8, wherein if the task is the flight of an aircraft, then the invariant data during the task comprises a type or model reference of the aircraft, a flight number of an aircraft, a departure airport of the aircraft, and an initial amount of fuel in the aircraft.
